(19) United States
(12) Patent Application Publication
(10) Pub. No.: US 2004/0248586 A1
(43) Pub. Date: Dec. 9, 2004

(54) Location markers on mobile devices

(75) Inventors: Biren R. Patel, Sunrise, FL (US); Jyh-Han Lin, Coral Springs, FL (US); Ruiqiang Zhuang, Plantation, FL (US)

Correspondence Address: FLEIT, KAIN, GIBBONS, GUTMAN, BONGINI, & BIANCO P.L., 551 N.W. 77TH STREET, SUITE 111, BOCA RATON, FL, 33487, US

(73) Assignee: MOTOROLA, INC., SCHAUMBURG, IL

(21) Appl. No.: 10/457,724

(22) Filed: Jun. 9, 2003

(51) Int. Cl. H04Q 7/20

(52) U.S. Cl. 455/456.1; 455/457

(57) ABSTRACT

A device (300) used to provide notifications based upon the location of the device (300). One or more location markers (500), which each have an associated region, are stored in the device (300). A notification, such as a visual and/or audible message, is provided by the device (300) upon entry into a region that is associated with one of the stored location markers (500). The notification can be particularized to the individual regions. The device can be assigned to a group and a set of location markers are delivered to all devices in that group so that each device of the group provides the same notification when the device enters a region associated with that set of location markers. The device can also be configured to provide the notification after the device has traversed a sequence of regions.

### FIELD OF THE INVENTION

The present invention generally relates to the field of geographic location determination devices and more particularly relates to a device and method of notification based on location determination.

### BACKGROUND OF THE INVENTION

Portable electronic devices, such as Personal Digital Assistants (PDAs) and cellular telephones, incorporate an increasing number of functions that assist the user of the device with everyday tasks. These devices include functions such as scheduling of notifications or reminders. These scheduling functions provide, for example, a notification to the user at a specified time that includes a user defined message or other data associated with the specified scheduled time. Such functions are able to provide notifications based upon time of day and are therefore limited in the scope of parameters that can be used to trigger providing a notification to the user of a portable electronic device. Providing additional triggering events to such devices will increase their utility and usefulness.

Therefore a need exists to overcome the problems with the prior art as discussed above.

### SUMMARY OF THE INVENTION

According to an exemplary embodiment of the present invention, a portable device comprises a geographic locator for determining a current geographic location of a device and a marker storage unit for storing at least one location marker. Each of the at least one location marker comprises at least one location condition that comprises a definition of an associated region. The portable device further comprises a location marker condition comparator, that is communicatively coupled to the geographic locator and the marker storage unit, and that determines a satisfaction of at least one location condition of one of the at least one location marker. The portable device also has a user notification indicator, that is communicatively coupled to the location comparator, and that provides a notification based upon the satisfaction.

According to another aspect of the exemplary embodiments, a method for providing notifications comprises determining a current geographic location of a device and storing at least one location marker. Each of the at least one location marker comprises at least one location condition that comprises a definition of an associated region. The method also determines a satisfaction of at least one condition of one of the at least one location marker and provides a notification based upon the satisfaction.

### BRIEF DESCRIPTION OF THE DRAWINGS

FIG. 1 is a geographic representation of locations and regions of interest as used by an exemplary embodiment of the present invention.

FIG. 2 is a front view of a location marker processing device according to an exemplary embodiment of the present invention.

FIG. 3 is an electrical block diagram of a location marker processing device according to an exemplary embodiment of the present invention.

FIG. 4 is an operational flow diagram illustrating an operational sequence of a location marker processing device according to an exemplary embodiment of the present invention.

FIG. 5 is a data structure diagram illustrating a linked list of location markers as used by a location marker processing device according to an exemplary embodiment of the present invention.

FIG. 6 is an operational flow diagram illustrating an operational sequence of a location marker processing device according to an exemplary embodiment of the present invention.

FIG. 7 is a data structure diagram illustrating a location marker data structure according to an exemplary embodiment of the present invention.

### DETAILED DESCRIPTION

FIG. 1 illustrates a geographic representation 100 of locations and regions of interest as used by an exemplary embodiment of the present invention. The geographic representation 100 is a “birds eye” view of three marked points, point A 102, point B 104 and point C 106. Each of the points shown in this geographic representation 100 has a circle with an associated radius around the point that defines a region. According to the present example, point A 102 is within circle 112 that encloses a region A, Point B 104 is within circle B 114 that encloses region B, and point C 106 is within circle C 116 that encloses region C. Each of these marked points and regions is associated with a location marker, as discussed below. An exemplary embodiment of the present invention monitors the current geographic location of a location marker monitoring device and determines if the device, and accordingly a user of the device, is located within one of the regions associated with a marked point. If a user is within a region that is associated with a location marker, the user has satisfied the location condition of that location marker. For example, a user with a location marker monitoring device that is at position X 120 is within region A and satisfies the location condition for the location marker associated with region A. Other conditions are optionally able to be associated with location markers and include time of day and/or other conditions according to exemplary embodiments of the present invention. Satisfaction of the location conditions and any other conditions of a location marker results in the satisfaction of the conditions of the location marker. In the example geographical representation 100, position Y 122 is not within any region and therefore no location markers have their location conditions satisfied when the user is at position Y 122. No location markers are therefore considered while a location marker processing device is located at position Y 122.

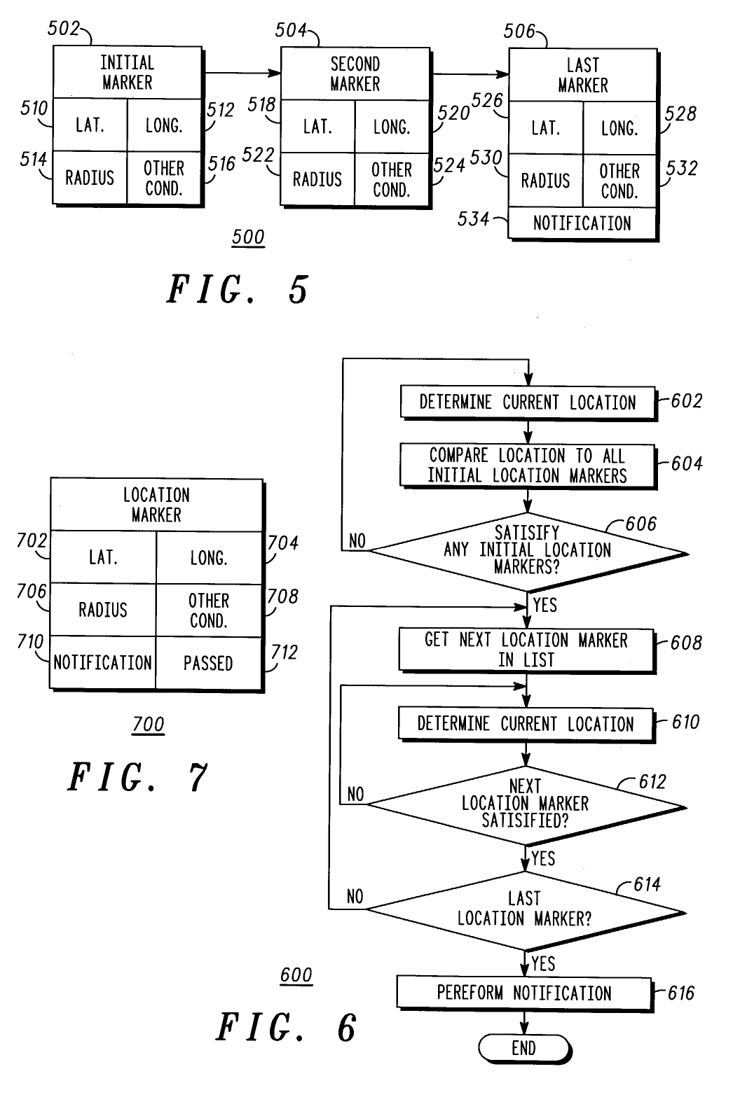

The processing of an exemplary embodiment of the present invention creates and stores a location marker for each marked point of interest, such as point A 102, point B 104, and point C 106. An exemplary location marker data structure 700 as is employed by an exemplary embodiment of the present invention is illustrated in FIG. 7. The location marker 700 has a specification of a latitude 702 and a longitude 704. The latitude 702 and longitude 704 define a location point that is associated with a point of interest, such as a business, customer residence, or other physical location. The exemplary embodiment associates a radius 706 with this location. If a user with a location marker processing device enters into the circle with the radius 706 that is centered at the latitude 702 and longitude 704, the location conditions of this location marker are satisfied. Other exemplary embodiments store specifications of more generalized regions, such as squares or other shapes, that are compared to the current location of the device. A circle is provided in this example to simplify explanation and understanding of the present invention. If the user with the location marker processing device that associates more complex regions with location markers passes within such a specified region, the location requirements of that location marker are then satisfied.

The locations, such as the latitude 702 and longitude 704, that are associated with a location marker 700 are able to be determined through a variety of methods. Locations are able to be determined by use of a geographic locator, such as a GPS receiver, that is position at a point of interest. This geographic locator is able to be part of a location marker processing device but any geographic locator is able to be effectively used to determine such locations. An external source, such as a remote user reading a map that can be a conventional paper map or computer based map, is also able to effectively provide the locations that are associated with a location marker. Other means of determining locations can similarly be used. The extent of the region to be associated with the location marker, such as the value of radius 706 in the exemplary embodiment, can also be selected with the aid of a map, by judgment of an individual defining the location marker, or by other methods.

Once the location conditions are satisfied, the processing of the exemplary embodiments determines whether other conditions 708 are satisfied. The other conditions field 708 is able to include a time of day range or other parameters that are relevant to a particular application. The other conditions field 708 can be set to “NONE” or to a value that otherwise indicates that there are no other conditions and that simply entering the region associated with the location marker satisfies all of the conditions of that location marker. The other conditions field 516 can thus have zero, one or more other conditions defined and that must be satisfied to determine that the location has been successfully passed.

If no conditions are specified, then simply satisfying the location condition by entering into the or other region, such as the circle defined by the latitude 702, longitude 704 and radius 706, satisfies all of the conditions of the location marker 700. In the example of a time of day range specification within the location marker 700, entering the region defined by the latitude 702, longitude 704 and radius 706 within the specified time of day satisfies the conditions of the location marker 700. But entering the same circle outside of the specified time of day range does not satisfy the conditions of the location marker 700.

If the conditions of the location marker 700 are satisfied, the processing of the exemplary embodiment provides a notification 710 to the user. The notifications that are provided are dependent upon a particular application. Example notifications include a visual alert to the user, such as an alphanumeric or graphical message presented upon display 308. Another example notification includes an audible alert such as provided by a speaker output or an audible indicator output. In addition to providing the notification, the processing of the exemplary embodiments are also able to indicate that the user has satisfied the conditions of a location marker 700 by setting the “Passed” flag 712 for use in further processing according to the particular application.

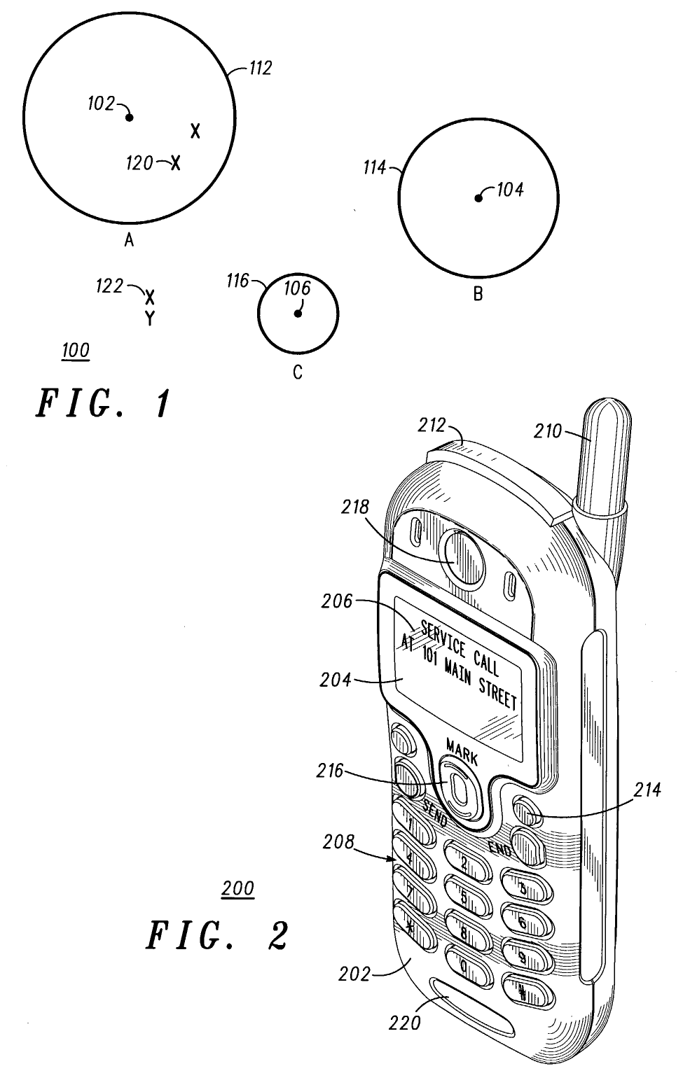

A front view of a location marker processing device 200 according to an exemplary embodiment of the present invention is illustrated in FIG. 2. The location marker processing device 200 of this exemplary embodiment is incorporated into a portable radio communications device 202 that operates as a cellular telephone. The location marker processing device 200 has operator controls that correspond to a conventional cellular telephone such as a keypad 208 and control keys 214 that include a SEND button and an END button. The control keys 214 further contain a MARK key 216 to allow the user to store the current geographic location of the location marker processing device 200 and to thereby define a new location marker. The location marker processing device 200 of this exemplary embodiment includes a radio communications antenna 210 and a GPS receiver antenna 212. A speaker 218 and microphone 220 are also included, such as to allow voice communications.

The location marker processing device 200 also has user display 204 that comprises an LCD display in the exemplary embodiment. The display 204 in this example contains a visual text message 206 indicating “SERVICE CALL AT 101 MAIN ST.” This illustrates an example where the user has satisfied the conditions of a location marker that is associated with a location at 101 Main Street. This exemplary message is a notification to the user of the location marker processing device 200 that a service call is required at that location. This application is particularly useful to a service company that has many individuals that require service or other types of visits by its personnel. This application sends the exemplary location marker for 101 Main Street to all members of a service group, and when one of these members is within the region defined by that service marker, the notification is provided to that service group member.

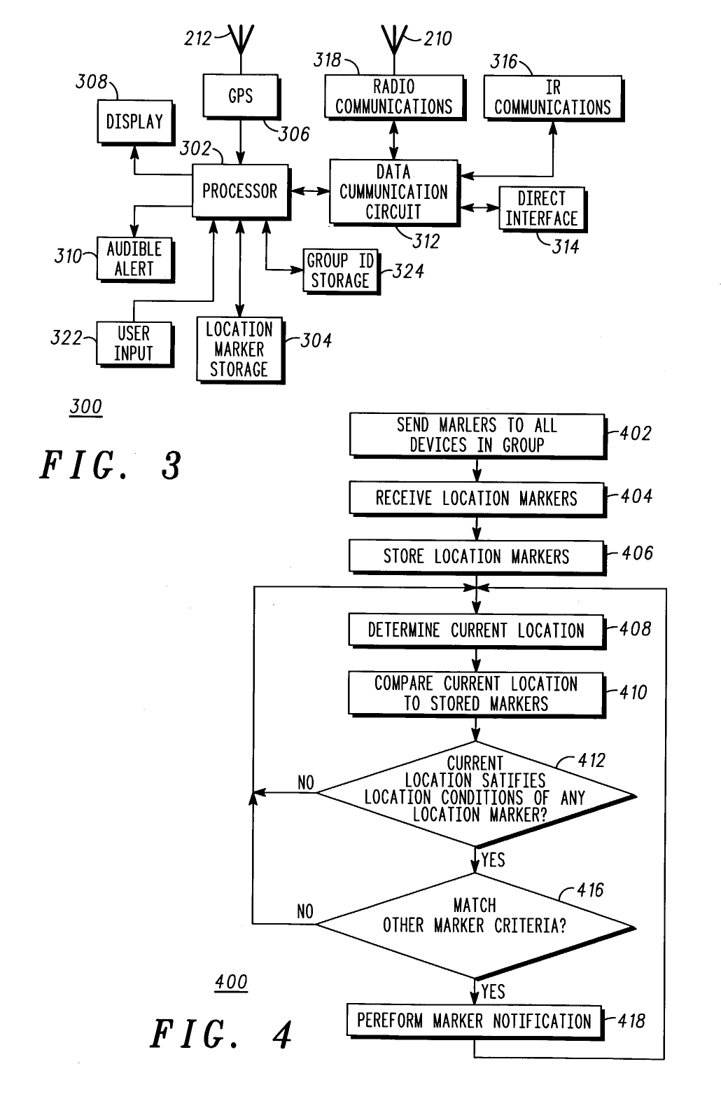

A location marker processing device block diagram 300 according to an exemplary embodiment of the present invention, is illustrated in FIG. 3. The exemplary location marker processing device 300 includes a processor 302 that comprises a programmable electronic processor configured to perform the processing of the exemplary embodiment. The processing performed by the processor 302 of the exemplary embodiment produces data that is presented to the user by either the display 308 or an audible alert 310. The display 308 of the exemplary embodiment comprises a Liquid Crystal Display (LCD) device adapted to present alphanumeric and/or graphical data to the user. The audible alert 310 comprises a sound generator designed to provide an audible alert output signal or a more complex audio signal to notify the user of different conditions. Embodiments of the present invention may include audible alert 310 devices that generate complex sounds and/or synthesized voice messages to better and more pleasingly alert the user.

The processor 302 further is coupled to a user input device 322 that comprises a conventional telephone keypad 208 and an additional “mark” key 216 to allow the user to “mark” the current location. Marking of the current location causes the geographical location, such as the latitude and longitude in the exemplary embodiment, to be stored in a memory of the device. A notification is then able to be associated with that geographical location to form a new location marker for the current location. The exemplary embodiment provides text prompts to the user via the display 308 to allow the user to assign common notifications, and to provide a name for the marked location, by pressing specified keys of the user input device 322. Other conditions to be satisfied are also able to be entered by the user and stored in memory for this new location marker. Embodiments of the present invention include enhanced user input devices 322 to facilitate the entry of more varied information. New location markers that are associated with user marked locations are also able to be transmitted to other location, such as a central server or to other location marker processing devices 200, as is described below.

The processor 302 accepts data from and provides data to a data communications circuits 312 component. The data communications circuits 312 provide data processing and interface functions to support data exchange through a radio communications 318 component, an infrared communications 316 component and/or a wired communications direct interface 314. Data communicated through the data communications circuits include location marker information. Location marker information in the exemplary embodiment includes the data described above and includes a geographic location of the geographic point associated with the marker, a radius or other region definition around that geographic location that defines a region of interest associated with the location marker, and a notification to be executed when the location marker device is located within the region of interest for that location marker. The data communications circuits 312 are able to receive and handle location marker information from other devices as well as transmit location marker information to other devices. Location marker data is communicated between or among multiple location marker processing devices 200 via various networking architectures, including broadcast from a central server to multiple devices or among devices in a peer-to-peer network. Other conventional network architectures are also able to be used for such communications. Location markers that are associated with new locations marked by the user of a location marker processing device 200 by pressing the MARK key 216 can be similarly transmitted to one or more other devices, such as a server or group of location marker processing devices 200, by such networks. The data communications circuits 312 work in conjunction with other communications circuits, such as those described below, to implement a location marker communications component.

The data communications circuits 312 are able to utilize radio communications 318 components to transmit and receive location marker information over wireless radio links via radio antenna 210. The exemplary embodiment includes RF communications circuits 318 that have hardware and other processing components that enable bi-directional data communications over conventional cellular telephone circuits as well as over conventional wireless data networks that are adapted for long range or short range communications. Examples of wireless communications networks with which the RF communications circuit 318 operate are the Motorola iDEN network, 802.11b data networking system, satellite based communications systems, Bluetooth data communications system as well as other such systems. The infrared (IR) communications component 316 includes hardware and other processing components to allow bi-directional data communications over an infrared link to a device within line-of-sight of the location marker processing device. The IR communications component is typically employed to allow communications between or among similar location marker processing devices or to an infrared “base station” that facilitates uploading and downloading of data from and to the location marker processing device.

Direct wired interface circuits 314 allow a location marker processing device to communicate over a direct data communications link. Embodiments of the present invention incorporate direct interface circuits 314 that support RS-232, Universal Serial Bus (USB), Ethernet, Firewire, proprietary and other directly connected data interfaces. The direct wired interface circuits 314 are also able to be connected to wireless communications devices, such as external radio modems, to perform the communications used by the embodiment of the present invention. Embodiments of the present invention are also able to utilize a combination of directly wired and wireless communications systems to perform communications used by those embodiments.

Location marker information is received through the data communications circuits 312 or is entered by a user via the user input device 322 in the exemplary embodiments. Location marker information that is received by the processor 302 is stored in the location marker storage unit 304 in the exemplary embodiment. The processor 302 then retrieves location marker information from the location marker storage and compares the current location of the location marker processing device to the region associated with each location marker. The current geographic location of the location marker processing device is determined by geographic locator, such as a GPS receiver 306 that receives GPS signals via the GPS antenna 212 in the exemplary embodiment. Alternative embodiments utilize other geographic locators, such as LORAN, time difference of arrival (TDOA) radio location systems, or other location systems. Local area location system, such as a location system that operates within a warehouse, factory, or other physical or geographic area, are also able to be effectively used by the exemplary embodiment of the present invention.

The processor 302 further has a Group Identification storage 324. The group identification storage stores one or more group identifiers for the location marker processing device. A group identifier is assigned to each location marker processing device in a defined group and a list of location markers is then sent, by any communications means including the wireless and wired communications means discussed herein, to each device that is configured with the same group identifier in the Group Identification storage 324. The assignment of a group identifier to a group of location marker processing devices allows, for example, a work group to be defined and each member of that workgroup is provided the same notification if that member satisfies the location marker conditions. This group identifier can be used for network communication and/or distribution of group location markers, including location marker information distributed by a location marker processing device 200 over a peer-to-peer network or by a central server over any network architecture. The network may comprise any of wired and/or wireless communications.

A group location markers operational flow diagram 400, according to an exemplary embodiment of the present invention, is illustrated in FIG. 4. Embodiments of the present invention may be used in systems that broadcast location markers to groups of location marker processing devices. This architecture allows multiple location marker processing devices, which are collectively referred to as a group, to receive identical sets of common location markers, and then each user of these location marker processing devices will be alerted with the specified notification when that person enters a zone of interest for any of the common location markers that were delivered to this group.

Groups of location marker processing devices are defined, created and maintained in various manners dependent upon the particular application. Examples of group definitions include group membership based upon radio transceiver identification and group membership based upon a list of radio transceiver identifiers. The definition of groups is able to be performed as part of the radio communication infrastructure, such as by a cellular telephone infrastructure of a cellular telephone system that establishes a “group identification number” that corresponds to a number of radio transceivers that operate with that cellular telephone system. In such a system, a transmission of data to the group identification number results in the data being transmitted to all of the radio transceivers in that group. Group definitions are also able to be implemented by other conventional data networking techniques, as should be obvious to those of ordinary skill in the art in view of the present discussion.

Referring to FIG. 4, the processing of group location markers begins by sending, at step 402, a set of location markers to all location marker processing devices in the group. The processing then proceeds wherein all of the location marker processing devices with the proper group identifier receive, at step 404, the transmitted location markers. These location markers are then stored, at step 406, into the location marker storage unit 304 for use by further processing by the processor 302.

The group location marker processing then enters a loop that begins by determining, at step 408, the current location of the location marker processing device. The current location is determined in the exemplary embodiment by GPS receiver 306. The processing then advances by comparing, at step 410, the current location to the region that is associated with each location marker stored in the location marker storage unit 304.

The processing then advances to determine, at step 412, whether the current location satisfies the location condition that is associated with any location marker stored within the location marker storage unit 304. A satisfaction of the location condition of a location marker is determined by a location marker condition comparator, which is performed by the software programmed into processor 302 in the exemplary embodiment. If no location conditions associated with stored location markers are satisfied by the current location, the processing returns to determining, at step 408, the current location.

If the current location satisfies a location condition associated with a stored location marker, the processing continues by determining, at step 416, whether other conditions of the location marker are satisfied. Location markers are able to have other associated conditions, such as time of day, that have to be satisfied in order to trigger providing the notification associated with that location marker. If these other conditions are not satisfied, the processing returns to determining, at step 408, the current location.

If the other criteria are satisfied, or if there are no other criteria associated with the location marker whose location condition is satisfied by the current location, the processing continues by providing, at step 418, the notification that is associated with this location marker. Notifications that are able to be associated with a location marker include one or more of an audible alert to be provided to the user, a visual message being displayed to the user, or other processing that is useful to the particular application. Once the notification is provided, the processing returns to determining, at step 408, the current location.

An embodiment of the present invention may determine if a user with a location marker processing device 200 has passed through a sequence of regions that are specified in a plurality of location markers. If the geographic locator produces a sequence of current locations that indicates that a user has satisfied the conditions of a passed through a specified percentage or all of the regions that are associated with a sequence of and has satisfied any other conditions that are associated with those regions, a notification is provided to the user or transmitted to a remote location. Some of these embodiments of the present invention can be configured to provide the associated notification when the user passes through all, or a subset of all, of the regions in any sequence. Other embodiments can be configured to provide the notification only if the specified locations are passed within a specified timeframe. This time frame can be specified by an absolute end time or by a time after the first location is passed by the user with the location marker processing device. These regions can be specified by a sequence of location markers that are similar to the location markers described above.

A data diagram of a sequential location marker linked list 500 as is used by a location marker processing device according to an embodiment of the present invention is illustrated in FIG. 5. The sequential location marker linked list 500 of the exemplary embodiment contains a sequence of location markers that specify a sequential list of regions through with a user with a location marker processing device must pass in order to trigger providing an associated notification. The sequential location marker linked list has an initial marker 502 that contains a latitude specification 510, a longitude specification 512, a radius 514 and other conditions 516. A region that is associated with this initial location marker 502 is defined as a circle with radius 514 that is centered at the specified latitude 510 and the specified longitude 512. The other condition field 516 specifies other conditions that must be satisfied in order to satisfy all of the conditions of this location marker. An exemplary other condition is a range of time of day. If the user with the location marker processing device passes through the region associated with the location marker but not within the range of time of day as specified by the other condition field 516, the conditions of that marker are not satisfied.

The initial marker 502 of this exemplary sequential location marker linked list 500 is linked to a second marker 504. The processing of embodiments of the present invention that process sequential location marker linked lists determines if the conditions of the second marker 504 are satisfied after the conditions of the initial marker 502 are satisfied. This determination of satisfaction of the conditions of the second marker 504 is similar to determination of satisfaction of the conditions of the initial marker 502. The second marker 504 is able to be followed by any number of location markers.

A last marker 506 is at the end of this exemplary sequential location marker linked list 500. Sequential location marker linked lists may be able to have only two location markers, the initial marker 502 and the last marker 506, and not include a second marker 504 or other intervening location markers. The processing of embodiments of the present invention that process sequential location marker linked lists determine if the conditions of the last marker 506 are satisfied and if those conditions are satisfied, the processing of this embodiment assumes that all regions of the sequence of location markers have been passed and provides the notification 534 to the user. This notification 534 in this example is associated with the sequential location maker linked list 500. The notification or notifications associated with a sequential location marker linked list are similar to the notifications associated with location markers, as are described above.

A sequential path operational flow diagram 600 for a location marker processing device according to an embodiment of the present invention is illustrated in FIG. 6. The processing of the sequential path processing beings by determining, at step 602, the current location of the location marker processing device. The exemplary embodiments use a GPS receiver to determine the current location of the location marker processing device. Once the current location is determined, that location is compared, at step 604, to the regions that are associated with all of the initial location markers 502 that are stored in the location marker storage unit 304. This comparison of the current location to the region associated with a location marker is similar to the location comparison described above and is performed by a location marker condition comparator that is implemented in the processing of processor 302 in the exemplary embodiments. This location comparison includes determining if the current location is within a region defined by the location marker data, such as within a specified radius of the latitude and longitude that are associated with the location marker. If the current location is not determined, at step 606, to match a region associated with any initial location marker 502, the processing of the exemplary embodiment returns to determining, at step 602, the current location of the location marker processing device. Embodiments that allow the triggering of notifications if the specified regions are passed in any order store the sequence or group of location markers according to the requirements of those embodiments. Such embodiments determine if the current location matches a region that is associated with any of the stored location markers.

If the current location of the location marker processing device matches a region associated with an initial location marker 502, the processing of this exemplary embodiment retrieves, at step 608, the next location marker in the list from the location marker storage unit 304. The processing of this embodiment then advances to determine, at step 610, the current location of the location marker processing device. This current location is then compared, at step 612, to the region associated with the next location marker that was retrieved above. If the current location is determined not to fall within this region, the processing returns to determining, at step 610, the current location of the device. If the current location is determined to fall within the region associated with the next location marker, the processing advances to determine, at step 614, whether the previously retrieved next location marker is the last location marker in the specified sequence. If that location marker is determined to be the last marker in the specified sequence, the notification associated with that sequence is provided, at step 616, and the processing of this location marker sequence terminates. This notification is generally provided by this embodiment when the user is within the region defined by the last location marker. If this location marker is not determined to be the last location maker, the processing continues by retrieving, at step 608, the next location marker in the list. The processing then continues as described above.

The above embodiments are used to provide a notification to the user of the location monitoring processing device 200. Embodiments of the present invention are configured to provide a notification via a data communication circuit, such as via radio communications 318, IR communications 316 or direct interface 314. This allows a remote location to receive a notification of the satisfaction of a location marker's conditions or the satisfaction of conditions associated with a sequence of location markers.

The exemplary embodiments of the present invention advantageously allow a user to define geographic regions in which a notification or alert is to be provided. Upon entering a specified region, the notification is provided. This allows a notification to be based not only upon temporal criteria, as is conventionally used, but also upon special criteria so that reminders are provided as the person is near a facility, business or other type of location where the reminder is most useful.

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits.

Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A portable device, comprising:
a geographic locator for determining a current geographic location of a device;
a marker storage unit for storing at least one location marker, wherein each of the at least one location marker comprises at least one location condition that comprises a definition of an associated region;
a location marker condition comparator, communicatively coupled to the geographic locator and the marker storage unit, for determining a satisfaction of at least one location condition of one of the at least one location marker; and
a user notification indicator, communicatively coupled to the location comparator, for providing a notification based upon the satisfaction.

2. The portable device according to claim 1, wherein the device further has a group identification storage for storing a group identifier, wherein the group identifier associates the device to a group and wherein location markers are stored into the marker storage unit based upon the group identifier.

3. The portable device according to claim 1, wherein the notification comprises a visual message associated with one of the at least one location marker.

4. The portable device according to claim 1, wherein the marker storage unit stores a plurality of location markers, wherein the location comparator further accumulates a plurality of satisfactions of location conditions that are associated with the plurality of location markers and wherein the user notification indicator provides the notification based upon the accumulated plurality of satisfactions.

5. The portable device according to claim 1, wherein the at least one location marker further comprise at least one other condition, and wherein the user notification indicator provides the notification based further upon satisfaction of the at least one other condition of the one of the at least one location marker.

6. The portable device according to claim 1, wherein the at least one location marker is defined by a user of the portable device.

7. The portable device according to claim 1, wherein the at least one location marker is generated by an external source.

8. The portable device according to claim 1, further comprising a location marker communication component for communicating location markers between other portable devices and the marker storage unit.

9. The portable device according to claim 8, wherein the communications component communicates with other portable devices.

10. The portable device according to claim 8, wherein the communications component communicates with a central server.

11. A method for providing notifications, comprising:
determining a current geographic location of a device;
storing at least one location marker, wherein each of the at least one location marker comprises at least one location condition that comprises a definition of an associated region;
determining a satisfaction of at least one condition of one of the at least one location marker; and
providing a notification based upon the satisfaction.

12. The method according to claim 11, further comprising defining a group identifier for a device, wherein the group identifier associates the device to a group and wherein the storing of the location markers is based upon the group identifier.

13. The method according to claim 11, wherein the storing stores a plurality of location markers, wherein the determining further accumulates a plurality of satisfactions of location conditions that are associated with the plurality of location markers and wherein the providing provides the notification based upon the accumulated plurality of satisfactions.

14. The method according to claim 11, wherein the at least one location marker further comprise at least one other condition, and wherein the determining a satisfaction of at least one condition further comprises determining a satisfaction of the at least one other condition of the one of the at least one location marker.

15. The method according to claim 11, wherein the notification comprises a visual message associated with one of the at least one location marker.

16. The method according to claim 11, further comprising generating location markers within the device

17. The method according to claim 11, further comprising generating location markers externally to the device.

18. The method according to claim 11, further comprising communicating location markers between the device and other devices.

19. The method according to claim 19, wherein the communicating is performed between the device and a central server.

20. A computer program product comprising computer programming instructions for:
determining a current geographic location of a device;
storing at least one location marker, wherein each of the at least one location marker comprises at least one location condition that comprises a definition of an associated region;
determining a satisfaction of at least one condition of one of the at least one location marker; and
providing a notification based upon the match.
